(19) United States
(12) Patent Application Publication
(10) Pub. No.: US 2009/0030643 A1
(43) Pub. Date: Jan. 29, 2009

(54) METHOD FOR COLLECTING STATISTICS FOR MOVIE THEATERS

(76) Inventors: Timothy J. White, Webster, NY (US); Shoupu Chen, Rochester, NY (US); Nathan D. Cahill, Rochester, NY (US)

Correspondence Address: Frank Pincelli;Patent Legal Staff, Eastman Kodak Company, 343 State Street, Rochester, NY, 14650-2201, US

(21) Appl. No.: 11/782,738

(22) Filed: Jul. 25, 2007

(51) Int. Cl. G06M 11/00

(52) U.S. Cl. 702/127

(57) ABSTRACT

A movie theater includes an infrared camera disposed in an auditorium of a movie theater which infrared camera captures an image of one or more persons in the movie theater; and an algorithm that determines the number of persons present in the movie theater.

### FIELD OF THE INVENTION

The present invention relates to a system and method for automatic, image-content analysis of movie viewers. More specifically, the present invention relates to applying automatic, image-content analysis to an auditorium of a movie theater for determining the number of persons present in the auditorium.

### BACKGROUND OF THE INVENTION

Content providers in the movie theater industry are responsible for selling ad space as part of pre-feature “entertainment” in the theater. Currently, content providers' billing systems rely on estimates of how many people are exposed to the ads being played on movie theater screens prior to the feature starting. For example, estimates are based on ticket sales which can be inaccurate as many moviegoers arrive at or about movie start time, or are in the lobby buying popcorn and soda as the ads play. Although the presently known and utilized system and method for determining the number of persons present during pre-feature entertainment are satisfactory, improvements for overcoming the above-described drawbacks are desirable.

The present invention uses image processing algorithms and an infrared camera to generate an exact count, in a statistical sense, of how many people are exposed to an ad. These more realistic counts can aid the content providers in developing more accurate billing systems.

### SUMMARY OF THE INVENTION

The present invention is directed to overcoming one or more of the problems set forth above. Briefly summarized, according to one aspect of the present invention, the present invention resides in a movie theater having an infrared camera disposed in an auditorium of the movie theater which infrared camera captures an image of a plurality of persons in the movie theater; and an algorithm that determines the number of persons present in the movie theater.

### ADVANTAGEOUS EFFECT OF THE INVENTION

The present invention has the advantage of automatically gathering viewer statistics for movie theaters. Another advantage of this invention is that it enables content providers to add flexibility to their billing of clients for pre-feature ad space. Current billing models are based on “premium” ad space being defined as that just prior to the feature (or upcoming feature previews) starting. Content providers may be able to offer more flexible billing based on more accurate counts, and therefore expand their clientele.

### BRIEF DESCRIPTION OF THE DRAWINGS

FIG. 1 is a schematic diagram of an image processing system useful in practicing the present invention;

FIG. 2 is a flowchart illustrating the automatic, movie-theater, viewer statistics gathering method of the present invention;

FIG. 3A is an illustration of a static background image of the present invention;

FIG. 3B is an illustration of a foreground plus background image of the present invention;

FIG. 3C is an illustration of a foreground image of the present invention;

FIG. 4A is an illustration of a theater background scene of the present invention;

FIG. 4B is an illustration of a theater foreground plus background scene of the present invention;

FIG. 5 is a flowchart illustrating a scheme of capturing a plurality of foreground plus background images of the present invention; and

FIG. 6 is an illustration of a foreground image divided into a plurality of cells of the present invention.

### DETAILED DESCRIPTION OF THE INVENTION

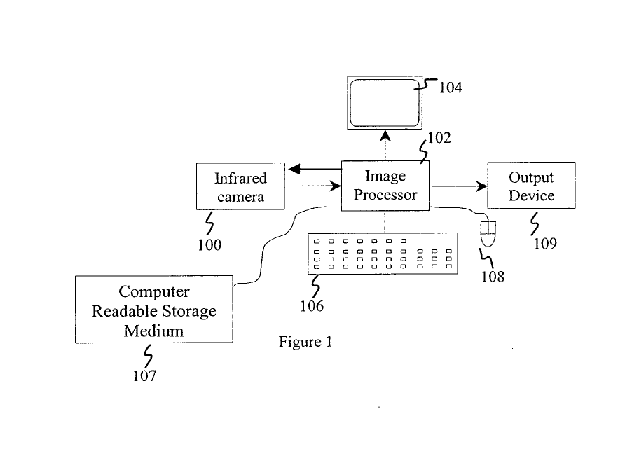

FIG. 1, shows an image processing system useful in practicing the present invention. The image processing system includes a digital camera, preferably an infrared digital camera 100, for capturing image in an auditorium of a movie theater. The infrared camera 100 is preferred because it provides quality images in low lighting conditions. The digital image from the digital, infrared camera 100 is provided to an image processor 102, such as a programmable personal computer, or digital image processing work station such as a Sun Sparc™ workstation. It is noted for clarity that the digital camera 100 can be controlled by the image processor 102. The image processor 102 is preferably connected to a CRT display 104 and a user interface, such as a keyboard 106 or a mouse 108. The image processor 102 is also connected to a computer readable storage medium 107 that stores software programs and applications. The image processor 102 transmits processed digital images to an output device 109. The output device 109 may comprise a hard-copy printer, a long-term, image storage device, a connection to another processor, or an image telecommunication device connected, for example, to the Internet, or a wireless device.

The image processor 102 is also connected to the Internet for receiving data from remote servers and other devices. In the present invention, the image processor 102 is connected to an Internet site so that the number of tickets purchased online can be determined. This is useful information for content providers in providing more flexible billing systems.

In the following description, it should be apparent that the computer program or algorithm of the present invention can be utilized by any well-known, computer system, such as the personal computer of the type shown in FIG. 1. However, many other types of computer systems can be used to execute the computer program or algorithm of the present invention. Alternatively, the method of the present invention can be executed in the computer contained in the digital camera 100 or a device combined or inclusive with a digital camera 100.

It will be understood that the computer program product of the present invention may make use of some image manipulation algorithms and processes that are well known. Accordingly, the present description will be directed in particular to those algorithms and processes forming part of, or cooperating more directly with, the method of the present invention. Thus, it will be understood that the computer program product embodiment of the present invention may embody algorithms and processes not specifically shown or described herein that are useful for implementation. Such algorithms and processes are conventional and within the ordinary skill in such arts.

Other aspects of such algorithms and systems, and hardware and/or software for producing and otherwise processing the images involved or co-operating with the computer program product of the present invention, are not specifically shown or described herein and may be selected from such algorithms, systems, hardware, components, and elements known in the art.

The computer program for performing the method of the present invention may be stored in a computer readable storage medium. This medium may comprise, for example: magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program. The computer program for performing the method of the present invention may also be stored on a computer readable storage medium that is connected to the image processor by way of the Internet or other communication medium. Those skilled in the art will readily recognize that the equivalent of such a computer program product may also be constructed in hardware.

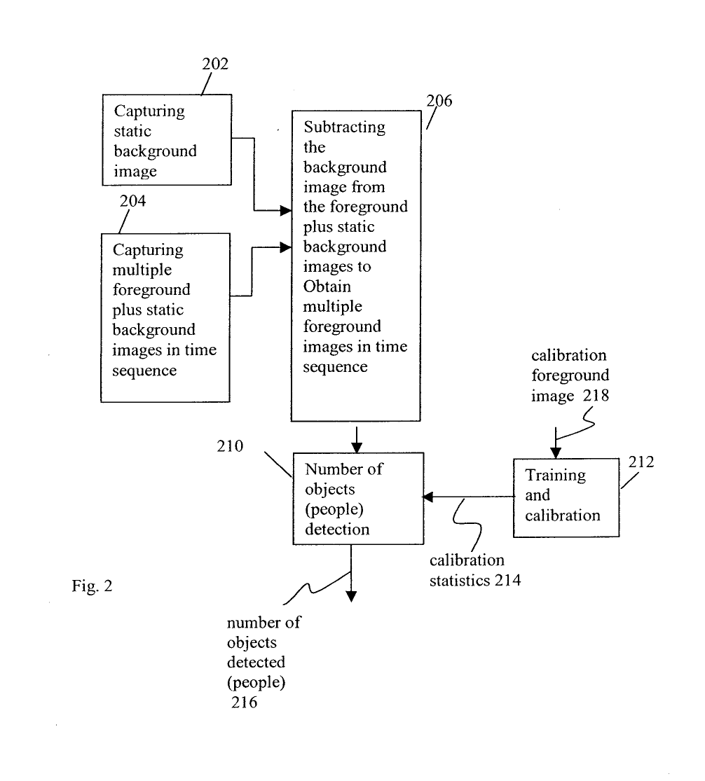

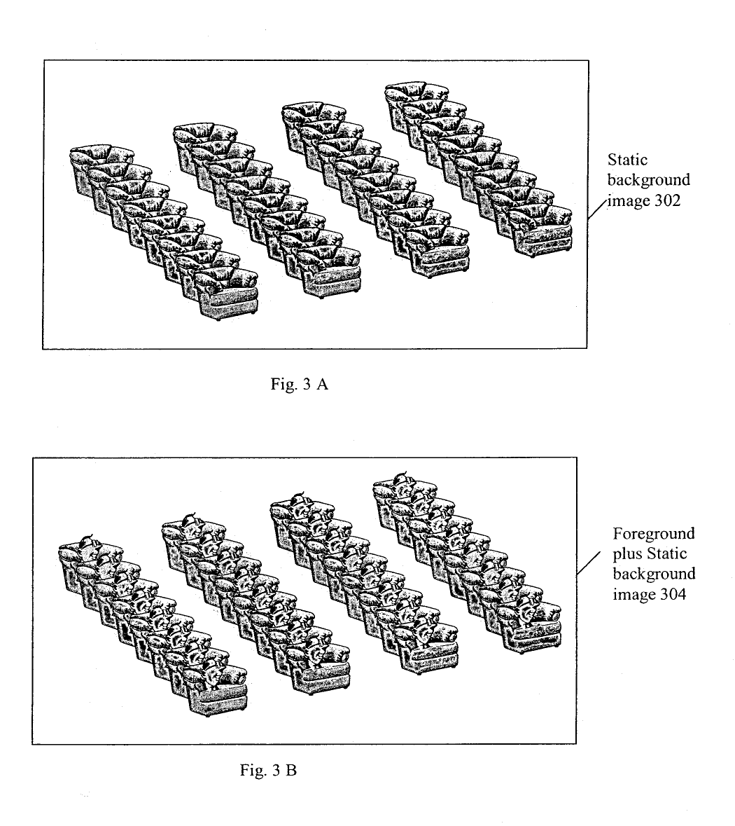

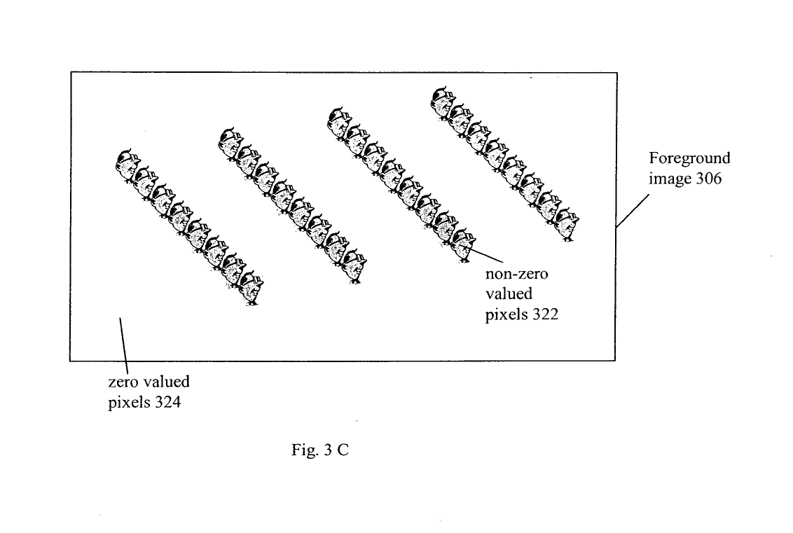

Now referring to FIG. 2, the method of the present invention is illustrated. FIG. 2 is a flowchart illustrating the automatic, viewer statistics gathering method according to the present invention. In step 202, a static background image is captured by the infrared camera 100. The infrared camera 100 preferably takes one or more pictures of the static background scene in an auditorium of the theater. The resultant image is a static background image 302, an example of which is shown in FIG. 3A. The theater background scene is generally time invariant for a period of time; for example, in one hour, or in one day. Therefore, the static back ground image 302 can serve as a reference image.

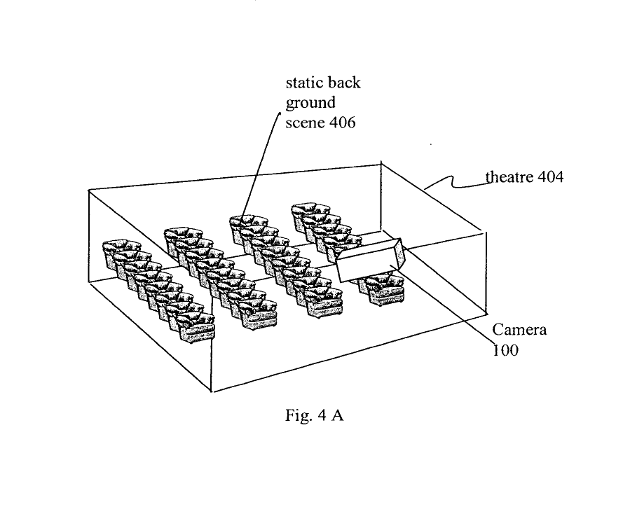

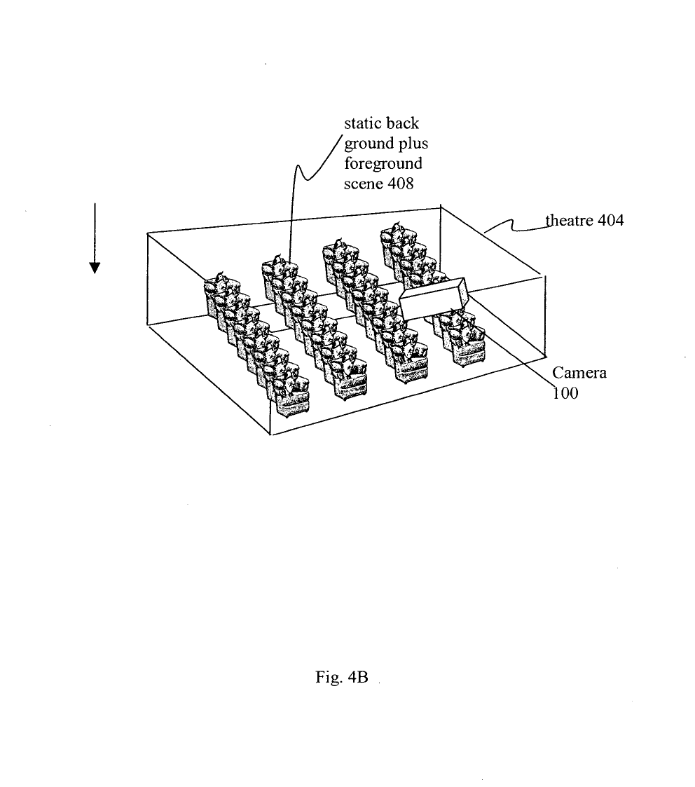

Referring briefly to FIGS. 4A and 3A, the theater 404 and its static background scene 406 is shown. The static background scene 406 includes any non-viewer or non-people objects (inanimate objects) such as seats and walls that are fixed relative to the camera 100. The seats and walls, in general, have unchanged shapes and positions in time. The static background scene image 302 of the background scene 406 is denoted by I^{B}. The fixed camera 100 could take a plurality of images of the background scene 406. Therefore, the static background scene image 302 I^{B} could be a statistical average of the plurality of background images.

In FIG. 4B, there is the theater 404 having the theater static background plus a foreground scene 408. The theater foreground includes a plurality of movie viewers. During the time of playing advertisements before the movie starts, the number of the movie viewers varies. As discussed in the background section, content providers' billing systems currently rely on estimates of how many persons are exposed to the ads being played on movie theater screens prior to the feature starting. A more precise measure for the billing purpose could be the viewer-time; that is, the product of the number of viewers present in the theater and the time span they are exposed to the ads. Therefore, as shown in FIG. 2, a step of capturing multiple foreground plus static background images in time sequence 204 is needed.

Referring back to FIG. 2, the algorithm of the present invention subtracts the static background image from the foreground plus static background images 206. In other words, the static background image I^{B} captured in step 202 is subtracted from each captured foreground plus background image. Therefore, a sequence of foreground images is obtained in step 206. An exemplary foreground image 306 is shown in FIG. 3C.

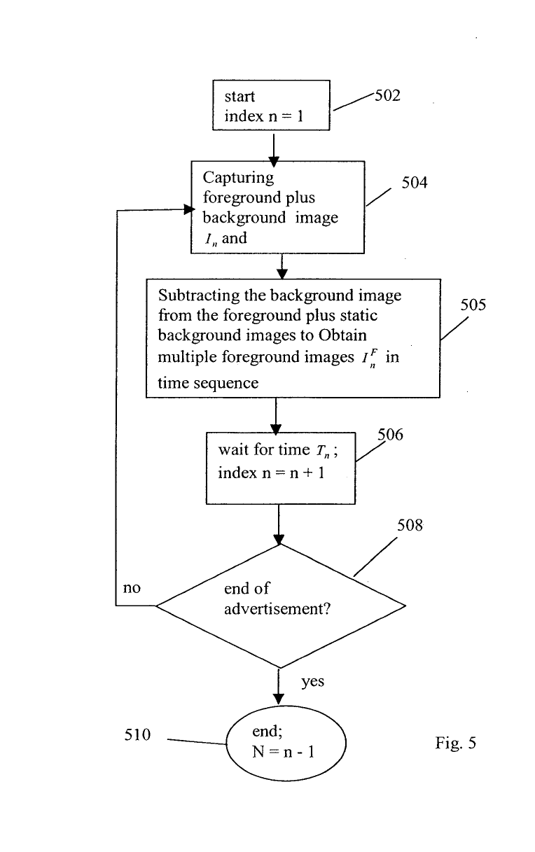

Referring to FIG. 5, the operation of the algorithm of the present invention of capturing multiple foreground plus static background images and obtaining a foreground image is described in detail. In a start step 502, an index n is initialized as 1. The camera 100 captures an image, I₁, of the foreground plus static background at the start time in step 504. An exemplary foreground plus static background image 304 is shown in FIG. 3B. The operation of camera 100 is controlled by the image processor 102.

In step 505, the static background image is subtracted from the foreground plus static background images Iₙ. Therefore, a sequence of foreground image, denoted by Iₙ^{F}, is obtained in step 505. An exemplary foreground image 306 is shown in FIG. 3C. The foreground images contain foreground objects that are non-zero, valued pixels 322. Areas in the foreground images other than the foreground object regions are filled with zero-valued pixels 324.

Referring back to FIG. 5, the program or algorithm executing via the image processor 102 waits for time T₁ and increases the index n by 1 in step 506. In a query step 508, a status of the theater operation is checked. If it is not the end of playing advertisement, camera 100 takes another foreground plus background image Iₙ in step 504. Then steps 505 through 508 are repeated. If it is the end of playing advertisement, the image capturing operation stops in step 510. In step 510, the total number of images, n−1, is recorded in variable N. Thus, the index n for the foreground plus static background image Iₙ, varies from 1 to N. The index n for the foreground image Iₙ^{F} varies from 1 to N, the same as the foreground plus background image Iₙ.

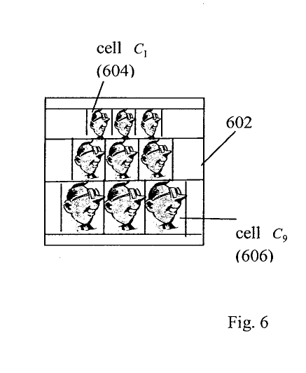

Referring back to FIG. 2, before the step of detecting the number of objects (people) 210 can be carried out, a step of training and calibration 212 preferably needs to be performed. The input to the step of training and calibration 212 is a calibration foreground image 218. This calibration foreground image is taken when the theater is full of movie viewers. An exemplary calibration foreground image 602 is shown in FIG. 6. To do the calibration, the camera 100 is properly oriented such that foreground image 602 is divided into a plurality of grid cells such as cell C₁ (604), and C₉ (606). Due to the perspective projection distortion, objects far from the camera appear smaller in the image; therefore, cell sizes are different. Note that the theater seats are fixed and the camera 100 can be fixed relatively to the seats so the cells can be readily defined in the image in the calibration stage. The exemplary foreground image 602 shows 9 viewers sitting on 9 seats. It is easy to understood that, if there is an empty seat, the cell corresponding to that seat in the foreground image is filled with zero-valued pixels. So, by counting the non-zero, valued pixels for a defined cell, it can be determined if there is a viewer sitting in a seat corresponding to that cell. A positive decision is made if the number of non-zero, valued pixels exceeds a threshold defined for that cell. An exemplary value of the threshold could be 90% of the cell size. Referring back to FIG. 2, the parameters of cell size, cell position in the image and non-zero, valued pixel count threshold are regarded as calibration statistics 214 to be used in the step of number of objects (people) detection 210.

To explain the operation of step 210, the following C-like code is used for the steps described in FIG. 2:

```
take background image I^{B}
n = 0;
while (not end of advertisement)
  {
    n = n + 1;
    take foreground plus static background Iₙ
    subtract I^{B} from Iₙ to get foreground image Iₙ^{F}
    for i = 1 to the defined number of cells
    {
if cell Cₙᵢ has the number of non-zero valued pixels > threshold
        Cₙᵢ = 1;
    }
    wait Tₙ;
}
```

In the above code, the operation, Cₙᵢ=1, indicates that there is viewer sitting at the seat corresponding to cell i in foreground image n. The total number of viewers (number of objects detected (people) 216) can be calculated as the summation

$${\sum }_{i} {C}_{i} ,$$

where Cᵢ=1,if any Cₙᵢ=1. A more precise measure for advertisement billing purpose could be the double summation

$${\sum }_{n} {\sum }_{i} {C}_{ni} {T}_{n} ,$$

that is, total viewer-time. It is understood that for people skilled in the art, there are other statistical methods for computing the measures for advertisement billing purpose.

It is to be understood that the algorithm and system of the present invention can be utilized in conventional movie theaters or a digital cinema.

The invention has been described with reference to one or more embodiments. However, it will be appreciated that variations and modifications can be effected by a person of ordinary skill in the art without departing from the scope of the invention. For example, the foreground images can be obtained directly by using an infrared camera instead of a conventional digital camera or a TV camera.

### PARTS LIST

100 digital infrared camera
102 image processor
104 CRT display
106 keyboard
107 computer readable storage medium
108 mouse
109 output device
202 flowchart step
204 flowchart step
206 flowchart step
210 flowchart step
212 flowchart step
214 flowchart step
216 flowchart step
218 flowchart step
302 static background image
304 foreground plus static background image
306 foreground image
322 non-zero, valued pixels
324 zero valued pixels
404 theater
406 static background scene
408 static background plus a foreground scene
502 flowchart step
504 flowchart step
505 flowchart step
506 flowchart step
508 flowchart step
510 flowchart step
602 a foreground image
604 a cell
606 a cell

What is claimed is:

1. A movie theater system comprising:
a) an infrared camera disposed in a movie theater which infrared camera captures an image of one or more people in the movie theater; and
b) an algorithm that determines the number of persons present in the movie theater.

2. The movie theater system as in claim 1 further comprising capturing both a static background image of the movie theater without people present and a foreground image of the movie theater having people present.

3. The movie theater system as in claim 2, wherein the algorithm subtracts the static background image from the foreground image in order to determine the number of people.

4. The movie theater system as in claim 3, wherein the algorithm is calibrated by taking a representative image of viewers in a movie theater and determining if a person is at one or more locations by comparing a first pixel value to a second pixel value.

5. The movie theater system as in claim 4, wherein the first pixel value is zero and the second pixel value is a non-zero value.

6. The movie theater system as in claim 5 further comprising a threshold value for determining when a person is present by determining when the non-zero pixel values exceed the zero pixel values by a predetermined amount.

7. The movie theater system as in claim 1 further comprising an online connection connected either to the algorithm or camera that counts tickets purchased online.

8. The movie theater system as in claim 1, wherein the algorithm determines a product of the number of viewers present in the auditorium and the time span they are exposed to the ads

9. A digital image processing method for automatically collecting viewer statistics from one or more persons in a movie theater, comprising the steps of:
a) capturing an image of the one or more persons in the movie theater with an infrared camera; and
b) using an algorithm to determine the number of people present in the movie theater.

10. The digital image processing method as in claim 9 further comprising the step of subtracting a static background image of the movie theater without people present from a foreground image of the movie theater having people present in order to determine the presence of one or more persons.

11. The digital image processing method as in claim 10 further comprising the step of calibrating a representative image of viewers by taking a representative image of viewers in a movie theater and determining if a person is at one or more locations by comparing a first pixel value to a second pixel value.

12. The digital image processing method as in claim 11 further comprising the step of providing the first pixel value as zero and the second pixel value as a non-zero value.

13. The digital image processing method as in claim 12 further comprising the step of providing a threshold by determining an amount by which non-zero pixel values exceed the zero pixel values.

14. The digital image processing method as in claim 9 further comprising the step of providing an online connection to the camera or algorithm that supplies the number of tickets purchased online.

15. The digital image processing method as in claim 9 further comprising determining a product of the number of viewers present in the auditorium and the time span they are exposed to the ads

16. A movie theater system comprising:
a) a camera disposed in an auditorium of a movie theater which camera captures both a static background image of the movie theater without people present and a foreground image of the movie theater having people present; and
b) an algorithm that determines the number of persons present in the movie theater by analyzing the foreground image and the static background image.

17. The movie theater system as in claim 16, wherein the algorithm subtracts the static background image from the foreground image in order to determine the presence of people.

18. The movie theater system as in claim 17, wherein the algorithm is calibrated by taking a representative image of viewers in the movie theater and determining if a person is at one or more locations by comparing a first pixel value to a second pixel value.

19. The movie theater system as in claim 18, wherein the first pixel value is zero and the second pixel value is a non-zero value.

20. The movie theater system as in claim 19 further comprising a threshold value for determining when a person is present by determining when the non-zero pixel values exceed the zero pixel values by a predetermined amount.

21. The movie theater system as in claim 16 further comprising an online connection connected to the algorithm or camera that counts tickets purchased online.

22. The movie theater system as in claim 16, wherein the algorithm determines a product of the number of viewers present in the auditorium and the time span they are exposed to the ads.
